(19) United States
(12) Patent Application Publication
(10) Pub. No.: US 2010/0110166 A1
(43) Pub. Date: May 6, 2010

(54) PROJECTING SYSTEM CAPABLE OF FORMING 3D IMAGES AND RELATED METHOD

(76) Inventor: Yao-Tsung Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/394,050

(22) Filed: Feb. 27, 2009

(30) Foreign Application Priority Data
Nov. 4, 2008 (TW) 097142504

(51) Int. Cl. H04N 13/04; G03B 21/14

(52) U.S. Cl. 348/57; 353/8; 348/E13.075

(57) ABSTRACT

A projecting system includes a lens for projecting images to a screen, an image generating device for outputting a first image during a first period and a second image during a second period alternately wherein a first polarization angle of the first image is different from a second polarization angle of the second image, an optical control unit for reflecting the first image or the second image transmitted from the image generating device to the lens, a polarizing unit for outputting the first image when rotating to a first angle and for outputting the second image when rotating to a second angle wherein an angular difference between the first angle and the second angle is 90 degrees substantially, and a driving device for driving the polarizing unit to locate at the first angle or at the second angle.

### BACKGROUND OF THE INVENTION

1. Field of the Invention

The present invention relates to a projecting system and related method, and more particularly, to a projecting system capable of polarizing images relative to a left eye polarization angle and a right eye polarization angle so as to form 3D images and related method.

2. Description of the Prior Art

Generally, 3D images are transmitted as left eye images and right eye images viewed by a left eye and a right eye, respectively. Images received by two eyes are matched as the 3D images in user's brain that has focal range and gradation according to a discrepancy between polarization angles of the two eyes. The common method utilizes different projecting devices. One of the projecting devices projects the left eye images and another one projects the right eye images. The left eye images and the right eye images having different polarization angles are usually orthogonal each other (such as one is α degrees and another is α+90 degrees). Both the images project on a screen respectively and the images reflected from the screen also have orthogonal polarization direction. After that, the viewer can wear a pair of corresponding polarizing glasses for enjoying the sight. The polarizing glasses utilize two orthogonal polarization lenses as a left eye lens and a right eye lens respectively so that the left eye and the right eye of the viewer can only view polarization beams of α degrees and α+90 degrees respectively. The two orthogonal polarization beams reflected from the screen can be received by the left eye and the right eye respectively so as to utilize vision persistence for matching as the 3D images in the viewer's brain.

However, utilizing different projecting devices to project the polarization beams of different polarization angles relative to the left eye images and the right eye images has following drawbacks: using two monstrous projectors wastes space; increasing hardware cost; integrating two projectors needs precise positioning or the images projecting on the screen can not be matched perfectly so as to occur situations of image dislocation or unequal focal length etc; and luminous flux of passed polarization beams decreases so that illumination of the images is weak and can not be viewed in an outside environment of high brightness. Thus, design of high imaging quality, and economizing instrument cost and mechanical space on the projecting system capable of forming the 3D images is an important issue in the 3D display industry.

### SUMMARY OF THE INVENTION

According to the claimed invention, a projecting system includes a housing, a lens for projecting images to a screen, an image generating device installed inside the housing for outputting a first image during a first period and a second image during a second period alternately wherein a first polarization angle of the first image is different from a second polarization angle of the second image, an optical control unit installed inside the housing for reflecting the first image or the second image transmitted form the image generating device to the lens, a polarizing unit for outputting the first image when rotating to a first angle and for outputting the second image when rotating to a second angle wherein an angular difference between the first angle and the second angle is 90 degrees substantially, and a driving device installed inside the housing for driving the polarizing unit to locate at the first angle or the second angle.

According to the claimed invention, the image generating device is used for outputting the first image relative to a left eye polarization angle during the first period and the second image relative to a right eye polarization angle during the second period alternately.

According to the claimed invention, the image generating device stops outputting the images except the first period and the second period.

According to the claimed invention, the image generating device includes a light source for generating images a converging lens for focusing the images generated by the light source, a color wheel for filtering the images transmitted from the converging lens so as to generate corresponding color beams, an integration rod for well mixing the color beams transmitted from the color wheel, a condenser lens for focusing the color beams transmitted from the integration rod, and a prism illumination device for reflecting the color beams transmitted from the condenser lens to the optical control unit.

According to the claimed invention, the optical control unit is a digital micromirror device (DMD) for reflecting the first image or the second image transmitted from the image generating device to the lens selectively.

According to the claimed invention, the polarizing unit is a polaroid.

According to the claimed invention, the polarizing unit is installed between the lens and the screen.

According to the claimed invention, the polarizing unit is combined with the lens.

According to the claimed invention, the polarizing unit is disposed on a surface of the lens.

According to the claimed invention, the polarizing unit is a polarizing membrane laid on the surface of the lens.

According to the claimed invention, the polarizing unit is formed on the surface of the lens by laser processing.

According to the claimed invention, the driving device is a motor.

According to the claimed invention, a projecting system further includes a first polarization lens for allowing the first image transmitted from the polarizing unit and reflected by the screen to pass through so as to receive the first image, and a second polarization lens disposed on a side of the first polarization lens for allowing the second image transmitted from the polarizing unit and reflected by the screen to pass through so as to receive the second image.

According to the claimed invention, the screen is made of aluminum or silver material.

According to the claimed invention, a projecting system is a digital light processing projector.

According to the claimed invention, a method for forming 3D images includes following steps: outputting a first image to a lens during a first period; rotating a polarizing unit to a first angle so as to polarize the first image transmitted from the lens to a screen, outputting a second image to the lens during a second period after the first period wherein a first polarization angle of the first image is different from a second polarization angle of the second image, and rotating the polarizing unit to a second angle so as to polarize the second image transmitted from the lens to the screen wherein an angular difference between the first angle and the second angle is 90 degrees substantially.

According to the claimed invention, outputting the first image to the lens during the first period includes outputting the first image relative to a left eye polarization angle to the lens during the first period, and outputting the second image to the lens during the second period after the first period includes outputting the second image relative to a right eye polarization angle to the lens during the second period after the first period.

According to the claimed invention, outputting the first image to the lens during the first period includes outputting the first image relative to a right eye polarization angle to the lens during the first period, and outputting the second image to the lens during the second period after the first period includes outputting the second image relative to a left eye polarization angle to the lens during the second period after the first period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a projecting system capable of forming 3D images according to a preferred embodiment of the present invention.

FIG. 2 is a flowchart of the projecting system forming the 3D images according to the preferred embodiment of the present invention.

FIG. 3 is a diagram of a polarizing unit locating at a first angle and a second angle according to the preferred embodiment of the present invention.

FIG. 4 is a diagram of relationship between polarization angles and projecting images of the polarizing unit during different periods according to the preferred embodiment of the present invention.

### DETAILED DESCRIPTION

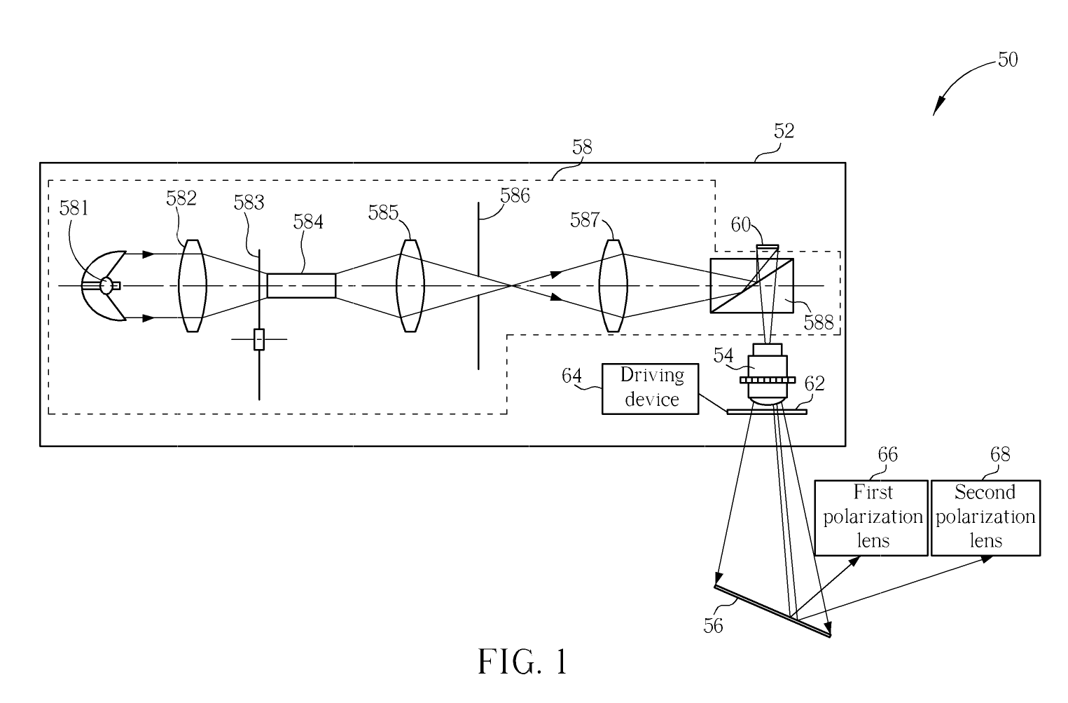

Please refer to FIG. 1. FIG. 1 is a diagram of a projecting system 50 capable of forming 3D images according to a preferred embodiment of the present invention. The projecting system 50 can be a digital light processing projector. The projecting system 50 includes a housing 52 for covering inner components, a lens 54 installed on the housing 52 for projecting images on a screen 56, and an image generating device 58 installed inside the housing 52. The screen 56 can be made of aluminum or sliver material so as to maintain polarization of the images generated by the image generating device 58. The image generating device 58 is used for outputting the images and can include a light source 581, a converging lens 582, a color wheel 583, an integration rod 584, a condenser lens 585, a stop 586, a relay lens 587, and a prism illumination device 588. The light source 581 is used for generating the images. The converging lens 582 is used for focusing the images generated by the light source 581 on the color wheel 583. The color wheel 583 is composed of a set of red, green, and blue filters wherein the set of red, green, and blue filters filter the images while the color wheel 583 rotates. When the images pass through the color wheel 583, the images transform as corresponding colorful beams. After that, the colorful beams pass through the integration rod 584 for well mixing illumination, pass over the condenser lens 585 and the stop 586, enter into the relay lens 587, and focus on the prism illumination device 588.

The projecting system 50 further includes an optical control unit 60. The optical control unit 60 installed inside the housing 52 can be a digital micromirror device. The prism illumination device 588 can reflect the colorful beams to the optical control unit 60. The optical control unit 60 can include a set of pixel lenses array capable of pivoting about ±12 degrees. The pixel lenses array capable of pivoting reflecting incident beams to the lens 54 names ON state, and the incident beams being reflected away position of the lens 54 names OFF state. According to the ON/OFF state of the optical control unit 60, the images containing information can be reflected from the set of pixel lenses array to pass through the prism illumination device 588 selectively, and to guide into the lens 54 for projecting on the screen 56.

The projecting system 50 further includes a polarizing unit 62. The polarizing unit 62 installed between the lens 54 and the screen 56 can be a polaroid for polarizing the images generated from the image generating device 58. The projecting system 50 further includes a driving device 64. The driving device 64 installed inside the housing 52 can be a motor for driving the polarizing unit 62 to locate at a first angle or a second angle. The projecting system 50 further includes a first polarization lens 66 and a second polarization lens 68. The first polarization lens 66 and the second polarization lens 68 can be combined as a pair of polarizing glasses. A viewer can view the 3D images output from the projecting system 50 by wearing the pair of polarizing glasses. The first polarization lens 66 and the second polarization lens 68 are two orthogonal polarization lenses so that the left eye and the right eye of the viewer only can view polarization beams of α degrees and α+90 degrees, respectively. The two orthogonal polarization beams reflected from the screen 56 can be received by the left eye and the right eye respectively so as to utilize vision persistence for matching as the 3D images in the viewer's brain.

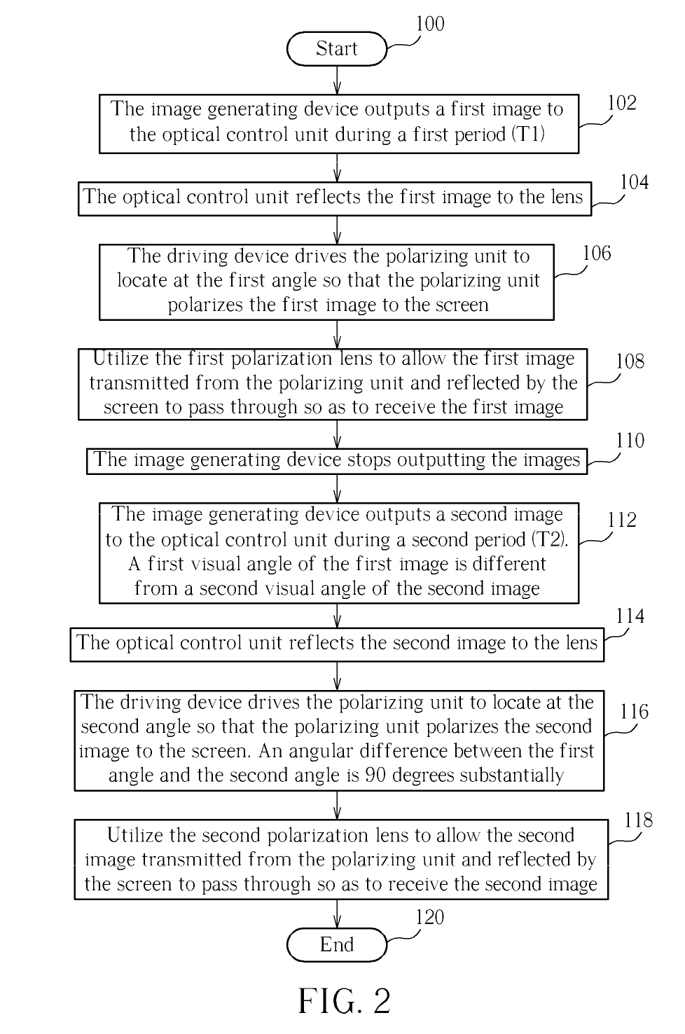

Please refer to FIG. 2. FIG. 2 is a flowchart of the projecting system 50 forming the 3D images according to the preferred embodiment of the present invention. The flowchart includes following steps:

STEP 100: Start.

STEP 102: The image generating device 58 outputs a first image to the optical control unit 60 during a first period (T1).

STEP 104: The optical control unit 60 reflects the first image to the lens 54.

STEP 106: The driving device 64 drives the polarizing unit 62 to locate at the first angle so that the polarizing unit 62 polarizes the first image transmitted from the lens 54 to the screen 56.

STEP 108: Utilize the first polarization lens 66 to allow the first image transmitted from the polarizing unit 62 and reflected by the screen 56 to pass through so as to receive the first image.

STEP 110: The image generating device 58 stops outputting the images.

STEP 112: The image generating device 58 outputs a second image to the optical control unit 60 during a second period (T2). A first polarization angle of the first image is different from a second polarization angle of the second image.

STEP 114: The optical control unit 60 reflects the second image to the lens 54.

STEP 116: The driving device 64 drives the polarizing unit 62 to locate at the second angle so that the polarizing unit 62 polarizes the second image transmitted from the lens 54 to the screen 56. An angular difference between the first angle and the second angle is 90 degrees substantially.

STEP 118: Utilize the second polarization lens 68 to allow the second image transmitted from the polarizing unit 62 and reflected by the screen 56 to pass through so as to receive the second image.

STEP 120: End.

The detailed description of above mentioned steps is as following. First, the image generating device 58 of the projecting system 50 can output the first image to the optical control unit 60 during the first period (T1). The image generating device 58 can generate the first image by the inner components as shown in FIG. 1, and the detailed description is omitted herein for simplicity. The first image can be the polarized images relative to a left eye polarization angle. After that, the optical control unit 60 reflects the first image to the lens 54, and the driving device 64 drives the polarizing unit 62 to locate at the first angle simultaneously. When the polarizing unit 62 is located at the first angle, the polarizing unit 62 can allow the first image relative to the left eye polarization angle transmitted from the lens 54 to pass through entirely, and then the first image is projected on the screen 56. The screen 56 can be made of aluminum or silver material so that the screen 56 can maintain polarization of the first image, that is, the polarization of the first image is not influenced after reflecting from the screen 56. When the viewer wears the pair of polarizing glasses combined with the first polarization lens 66 and the second polarization lens 68, the first polarization lens 66 worn on the left eye can allow the first image transmitted from the polarizing unit 62 and reflected by the screen 56 to pass through so as to receive the first image. Thus, the left eye of the viewer can view the polarization beams relative to the first angle.

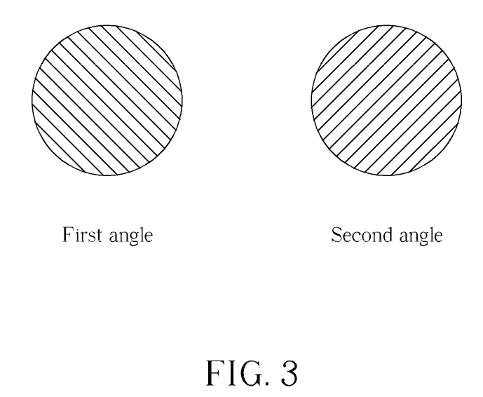

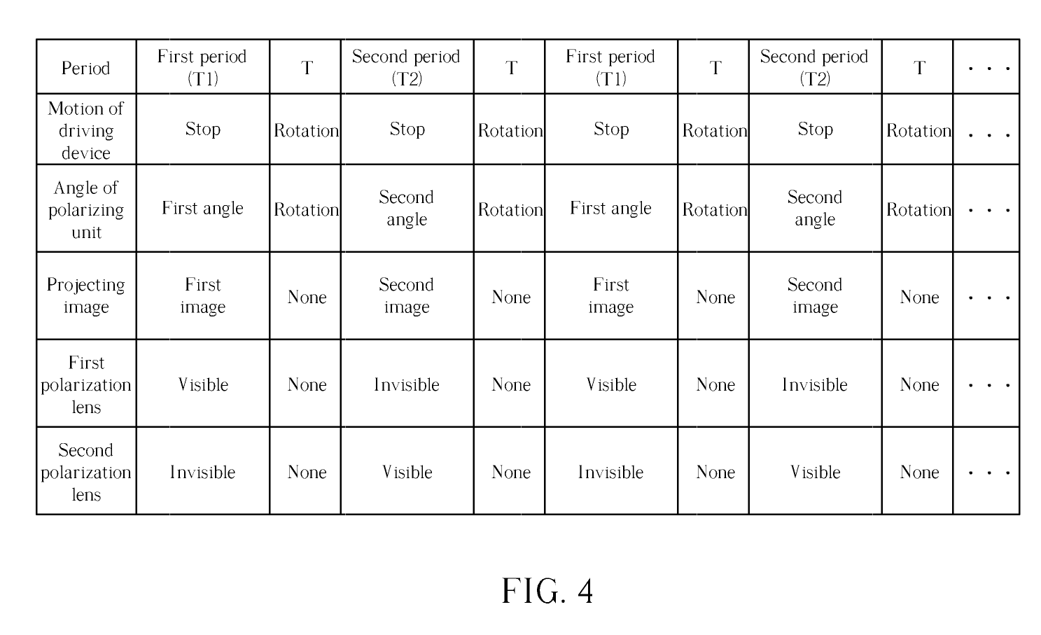

Afterward, when the driving device 64 drives the polarizing unit 62 from the first angle to the second angle, the image generating device 58 does not output any images so as to avoid generating the 3D images so that the viewer's left eye and right eye can not view the images respectively via the first polarization lens 66 and the second polarization lens 68 at the same time. When the driving device 64 has driven the polarizing unit 62 to locate at the second angle, the image generating device 58 outputs the second image to the optical control unit 60 during the second period (T2) simultaneously. The first period (T1) and the second period (T2) can be an isochronous period or a non-isochronous period. The image generating device 58 can generate the second image according to the inner components as shown in FIG. 1, and the detailed description is omitted herein for simplicity. The optical control unit 60 is used for reflecting the second image to the lens 54, and the first polarization angle of the first image is different from the second polarization angle of the second image. When the first image is the polarization beams relative to the left eye, the second image is the polarization beams relative to the right eye accordingly. The left eye images and the right eye images having different polarization angles are the orthogonal polarization beams generally, so the angular difference of the first angle and the second angle can be designed as 90 degrees substantially. Please refer to FIG. 3. FIG. 3 is a diagram of the polarizing unit 62 locating at the first angle and the second angle according to the preferred embodiment of the present invention. When the polarizing unit 62 is located at the second angle, the polarizing unit 62 can allow the second image relative to the right eye polarization angle transmitted from the lens 54 to pass through entirely so that the second image is projected on the screen 56. The screen 56 can be made of aluminum or silver material so that polarization of the second image can be maintained and not be influenced after reflecting from the screen 56. Similarly, when the viewer wears the pair of polarizing glasses combined with the first polarization lens 66 and the second polarization 68, the second polarization 68 wore on the right eye can allow the second image transmitted from the polarizing unit 62 and reflected by the screen 56 to pass through so as to receive the second image. Therefore, the viewer's right eye can view the polarization beams relative to the second angle. Please refer to FIG. 4. FIG. 4 is a diagram of relationship between polarization angles and projecting images of the polarizing unit 62 during different periods according to the preferred embodiment of the present invention. Step 102 to step 118 as mentioned above can be implemented repeatedly. That is, the image generating device 58 can output the image relative to the left eye during the first period (T1) and can output the image relative to the right eye during the second period (T2) alternately to generate a series of two alternately orthogonal polarization beams for being received respectively by the left eye and the right eye during different periods so as to utilize vision persistence for matching as the 3D images in brain finally.

In conclusion, the first angle and the second angle differ as 90 degrees substantially so that the left eye and the right eye of the viewer merely view the polarization beams of α degrees and α+90 degrees during the first period (T1) and the second period (T2) respectively for matching as the 3D images in brain due to vision persistence. In addition, the first image generated by the image generating device 58 during the first period (T1) can be the polarization images relative to the right eye polarization angle, and the second image generated by the image generating device 58 during the second period (T2) can be the polarization images relative to the left eye polarization angle accordingly. The operating principle is the same as the above embodiment, and the detailed description is omitted herein for simplicity.

Besides, the polarizing unit 62 not only can be an separate part installed between the lens 54 and the screen 56 but also can be combined with the lens 54. For example, the polarizing unit 62 can be sheathed on the lens 54 and can move with the lens 54 synchronously so that the driving device 64 can drive the polarizing unit 62 and the lens 54 synchronously. The polarizing unit 62 can be disposed on a surface of the lens 54. For example, the polarizing unit 62 can be a polaroid laid on the surface of the lens 54 or formed on the surface of the lens 54 by laser processing. Therefore, the driving device 64 also can drive the polarizing unit 62 and the lens 54 synchronously. All mechanisms of utilizing the polarizing unit 62 for outputting the images transmitted from the lens 54 selectively are within the scope of the present invention.

In contrast to the prior art, the present invention provides a projecting system capable of forming 3D images by simply one projector and related method. The present invention curtails mechanical space effectively, economizes hardware cost, diminishes the limitation of precise positioning between two projectors, and advances the decay of luminous flux of beams being polarized. The present invention provides a projecting system with high imaging quality, low instrument cost, and smaller mechanical space.

Those skilled in the art will readily observe that numerous modifications and alterations of the device and method may be made while retaining the teachings of the invention.

What is claimed is:

1. A projecting system comprising:
a housing;
a lens for projecting images to a screen;
an image generating device installed inside the housing for outputting a first image during a first period and a second image during a second period alternately wherein a first polarization angle of the first image is different from a second polarization angle of the second image;
an optical control unit installed inside the housing for reflecting the first image or the second image transmitted from the image generating device to the lens;
a polarizing unit for outputting the first image when rotating to a first angle and for outputting the second image when rotating to a second angle wherein an polarization angular difference between the first image and the second image is 90 degrees substantially; and
a driving device installed inside the housing for driving the polarizing unit to locate at the first angle or the second angle.

2. The projecting system of claim 1, wherein the image generating device is used for outputting the first image relative to a left eye polarization angle during the first period and the second image relative to a right eye polarization angle during the second period alternately.

3. The projecting system of claim 1, wherein the image generating device stops outputting the images except the first period and the second period.

4. The projecting system of claim 1, wherein the image generating device comprises:
a light source for generating images;
a converging lens for focusing the images generated by the light source;
a color wheel for filtering the images transmitted from the converging lens so as to generate corresponding color beams;
an integration rod for well mixing the color beams transmitted from the color wheel;
a condenser lens for focusing the color beams transmitted from the integration rod; and
a prism illumination device for reflecting the color beams transmitted from the condenser lens to the optical control unit.

5. The projecting system of claim 1, wherein the optical control unit is a digital micromirror device (DMD) for reflecting the first image or the second image transmitted from the image generating device to the lens selectively.

6. The projecting system of claim 1, wherein the polarizing unit is a polaroid.

7. The projecting system of claim 1, wherein the polarizing unit is installed between the lens and the screen.

8. The projecting system of claim 1, wherein the polarizing unit is combined with the lens.

9. The projecting system of claim 1, wherein the polarizing unit is disposed on a surface of the lens.

10. The projecting system of claim 9, wherein the polarizing unit is a polarizing membranelaid on the surface of the lens.

11. The projecting system of claim 9, wherein the polarizing unit is formed on the surface of the lens by laser processing.

12. The projecting system of claim 1, wherein the driving device is a motor.

13. The projecting system of claim 1 further comprising:
a first polarization lens for allowing the first image transmitted from the polarizing unit and reflected by the screen to pass through so as to receive the first image; and
a second polarization lens disposed on a side of the first polarization lens for allowing the second image transmitted from the polarizing unit and reflected by the screen to pass through so as to receive the second image.

14. The projecting system of claim 1, wherein the screen is made of aluminum or silver material.

15. The projecting system of claim 1 being a digital light processing projector.

16. A method for forming 3D images comprising:
outputting a first image to a lens during a first period;
rotating a polarizing unit to a first angle so as to polarize the first image transmitted from the lens to a screen;
outputting a second image to the lens during a second period after the first period wherein a first polarization angle of the first image is different from a second polarization angle of the second image; and
rotating the polarizing unit to a second angle so as to polarize the second image transmitted from the lens to the screen wherein an angular difference between the first angle and the second angle is 90 degrees substantially.

17. The method of claim 16, wherein outputting the first image to the lens during the first period comprises outputting the first image relative to a left eye polarization angle to the lens during the first period, and outputting the second image to the lens during the second period after the first period comprises outputting the second image relative to a right eye polarization angle to the lens during the second period after the first period.

18. The method of claim 16, wherein outputting the first image to the lens during the first period comprises outputting the first image relative to a right eye polarization angle to the lens during the first period, and outputting the second image to the lens during the second period after the first period comprises outputting the second image relative to a left eye polarization angle to the lens during the second period after the first period.

19. The method of claim 16 further comprises stopping outputting images except the first period and the second period.

20. The method of claim 16 further comprising:
utilizing a first polarization lens to allow the first image transmitted from the polarizing unit and reflected by the screen to pass through so as to receive the first image; and
utilizing a second polarization lens to allowing the second image transmitted from the polarizing unit and reflected by the screen to pass through so as to receive the second image.
